(19) United States
(12) Patent Application Publication
(10) Pub. No.: US 2009/0233648 A1
(43) Pub. Date: Sep. 17, 2009

(54) DEVICE FOR CONTROLLING DISPLAY OF MOBILE TERMINAL AND METHOD THEREOF

(75) Inventor: Wei Shen, Beijing (CN)

Correspondence Address: LERNER GREENBERG STEMER LLP, P O BOX 2480, HOLLYWOOD, FL, 33022-2480, US

(73) Assignee: Gmedia Corporation, George Town, Grand Cayman (KY)

(21) Appl. No.: 11/721,006

(22) PCT Filed: Oct. 28, 2005
(86) PCT No.: PCT/CN05/01779

§ 371 Date: Jun. 6, 2007

(30) Foreign Application Priority Data
Dec. 7, 2004 (CN) 200410009970.4

(51) Int. Cl. H04M 1/00

(52) U.S. Cl. 455/566

(57) ABSTRACT

The present invention discloses a device for controlling display of mobile terminal and the method thereof. The device includes: a mobile terminal for receiving, calculating and displaying information; the mobile terminal being configured with an information reading apparatus for reading information on an information carrier; a character storage for storing characters of different types and representing forms; a calculating apparatus for matching the read information with stored information in the character storage, and for generating correspondent character representing information and location information; a displaying apparatus for displaying graphic and text information. This invention can display the contents in the originality of advertisements at once by identifying a barcode with the mobile terminal. The advertisements can be displayed more rapidly and be represented finer, so that users are more attracted to take actions such as reading more advertisements from the network, logging in to take part in activities, placing orders and so on.

### TECHNICAL FIELD

The present invention relates to devices for controlling display of mobile terminal (especially mobile phone); and particularly to devices for controlling display of mobile phone by reading information and method thereof.

### BACKGROUND ARTS

Recently, mobile phone has been widely used, and camera mobile phone is gradually becoming the mainstream in the market. A mobile phone may identify encoded information such as barcode with an information reading apparatus (for example, camera apparatus), and may be linked to related contents and applications according to the direction of the information. By using this method, the mobile phone may access a network more conveniently to enjoy various services such as shopping, hotel booking, information browsing. On the other hand, content servers and advertisers may promote for their products and services by this technology and service.

However, in existing methods for reading barcode information by camera apparatuses of mobile phones, what obtained by decoding is plain text information, which is monotonously displayed on mobile phone. Because neither the font style, font size, color, background, effect, arrangement of the contents for displaying can be controlled, nor image information (for example, a Logo) may be controlled for image-text arrangement, the displaying effect is affected.

The patent document [publication Number] CN 1363065A discloses an information collecting system capable of acquiring information through a network by accessing the network, which comprises a pointer sending apparatus (non-contact IC card) for sending out pointers of information acquired from the network, a portable terminal having an accessing apparatus to the network and an accessing apparatus to the pointer sending apparatus, and an information providing apparatus for providing information via the network. The system is characterized in that the portable terminal uses a pointer, acquired by sending a request to the pointer sending apparatus, to acquire information from the information providing apparatus. The non-contact IC card is stuck to advertising media to facilitate the reading by the portable terminal and acquiring advertising information from the advertising server. The drawback of this system is that the speed for acquiring information is limited as the information may be acquired only when connected to a network, and the advertisement exhibiting effect is affected as the network browser supports only limited information displaying manners.

### SUMMARY OF THE INVENTION

The objective of the present invention is to provide a method for controlling display of mobile terminal, which is quick in information acquiring and good in graphic and text displaying effect.

To achieve the above-mentioned objective, the present invention utilizes a technical solution as follows: a device for controlling display of mobile terminal including a mobile terminal for receiving, calculating and displaying information; the mobile terminal being configured with an information reading apparatus for reading information on an information carrier; a character storage for storing characters of different types and representing forms; a calculating apparatus for matching the read information with stored information in the character storage, and for generating correspondent character representing information and location information; a displaying apparatus for displaying graphic and text information.

Due to the gradual popularity of mobile telephone with camera apparatus, it is convenient to access network to acquire more information, for example, by identifying barcodes. This invention can display the contents in the originality of an advertisement at once by identifying a barcode with the mobile terminal. The advertisement can be displayed more rapidly and be represented finer, so that users are more attracted to take actions such as reading more advertisement contents from the network, logging in to take part in activities, placing orders and so on.

### DESCRIPTION OF THE DRAWINGS

FIG. 1 is a block diagram of a device for controlling display of mobile terminal in accordance with the present invention;

FIG. 2 is a representation of barcode patterns in accordance with example 1 of the present invention;

FIG. 3 is a block diagram of an information writing apparatus in accordance with example 1 of the present invention;

FIGS. 4a, 4b are block diagrams of an information reading apparatus in accordance with example 1 of the present invention;

FIGS. 5a, 5b are schematics of contents displayed on a mobile terminal and coding information in accordance with example 1 of the present invention;

FIG. 6 is a flow chart of calculation within a mobile terminal in accordance with example 1 of the present invention;

FIGS. 7a, 7b are schematics of contents displayed on a mobile terminal and coding information in accordance with example 2 of the present invention;

FIG. 8 is a flow chart of calculation within a mobile terminal in accordance with example 2 of the present invention;

FIG. 9 is a block diagram of a non-contact IC card (RFID) in accordance with example 3 of the present invention;

FIG. 10 is a block diagram for information writing and reading process in accordance with example 3 of the present invention; and

FIGS. 11a, 11b are schematics of coding information of an information carrier in accordance with example 4 of the present invention.

### DETAILED EMBODIMENTS

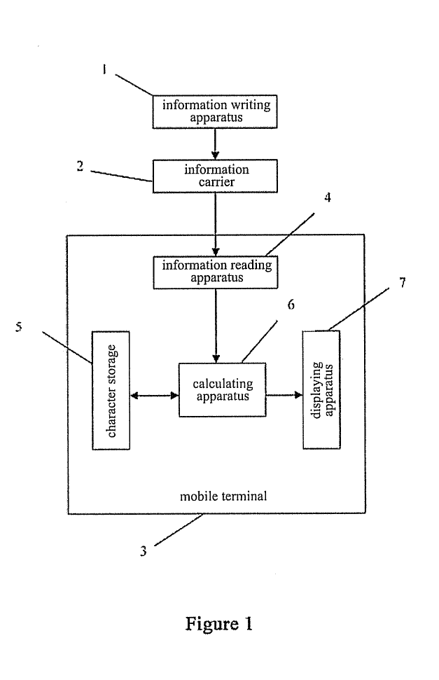

As shown in FIG. 1, an information writing apparatus (1) writes information which includes text information, image information and control information into an information carrier (2). Then the information in the information carrier (2) is read through an information reading apparatus (4) installed in or connected to a mobile terminal (3). The read information is matched with stored information in a character storage (5) through a calculating apparatus (6), and corresponding character representing information and location information are generated, which are eventually displayed through a displaying apparatus (7) of the mobile terminal (3) in conjunction with the image information.

The information carrier may be formed of encodable and automatically identifiable graphics such as a barcode. For example, the information carrier may be one-dimensional barcode or two-dimensional barcode.

The information carrier may also be formed of non-contact IC card, such as RFID.

The information writing apparatus may be an apparatus for encoding the text information, the image information, the control information and the like and writing the encoded information into the information carrier to form automatically identifiable graphics (for example, barcode).

The information writing apparatus may also be non-contact IC card reading/writing apparatus, such as RFID reader/writer.

The mobile terminal includes the information reading apparatus installed in or connected to the mobile terminal, the calculating apparatus, the character storage, the displaying apparatus, a communication apparatus and so on.

The information reading apparatus is a reading apparatus such as a digital camera, a barcode identifying device, a RFID reader/writer and the like. The reading apparatus is installed on or connected to the mobile terminal device. The reading apparatus may identify the encoded information on the information carrier, and may acquire coding information. The information reading apparatus transfers the coding information to the calculating apparatus in the mobile terminal.

The calculating apparatus is a processor such as CPU and the like, which is built-in the mobile terminal. The calculating apparatus matches the information read by the information reading apparatus with the stored information in the character storage, generates corresponding character representing information and location information, and outputs these kinds of information to the displaying apparatus.

The character storage is a storing unit such as RAM or ROM for storing characters of various types and representing forms, which includes character set, font style, font size, color, background, effect and so on.

The displaying apparatus is a display screen (such as a LCD) with a control unit for displaying text and image information.

### Example 1

In a device for controlling display of mobile terminal in accordance with example 1 of the present invention, a barcode is employed as information carrier.

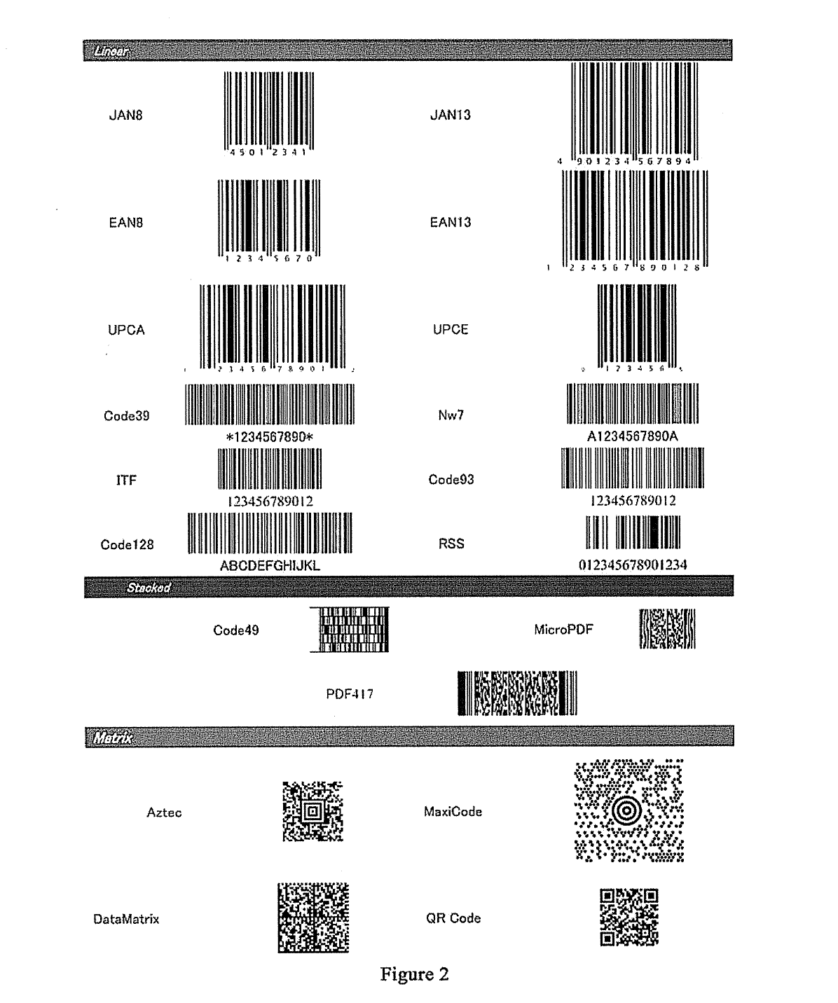

FIG. 2 lists some patterns of one-dimensional barcode and two-dimensional barcode. A barcode is formed of monochrome graphics which are encodable and automatically identifiable. It may be encoded by computer and can be made on a barcode printing device, or it may be generated by outputting electronic files to a lithographing and typesetting device or a film outputting device, and being lithographed and printed in connection with printed matters. The graphic data of a barcode may be read by a photoelectric sensing element such as CCD or CMOS, and may be interpreted to the previously compiled data by a decoding apparatus.

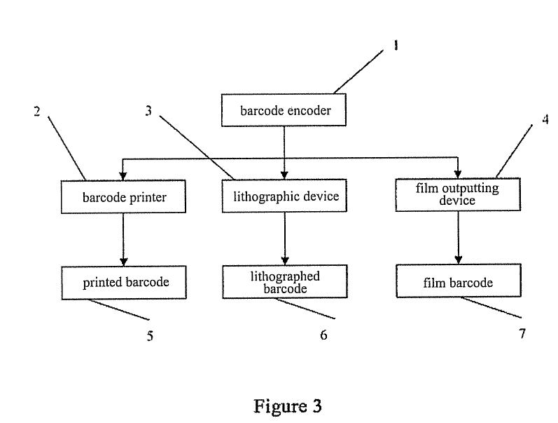

FIG. 3 is a block diagram of an information writing apparatus. Information, for example, text information, image information, control information and so on, is input into a barcode encoder (1) by computer. The barcode encoder brings the information into correspondence with a piece of or a set of coding information, and transforms the coding information into barcode graphic information. The barcode graphic information is input into a barcode printer (2), and is printed as a printed barcode (5); alternatively, the barcode graphic information is input into a lithographic device (3), and is typeset and lithographed or printed with text and graphic to be lithographed as a lithographed barcode (6); or alternatively, the barcode graphic information is input into a film outputting device (4), and is output on films with text and graphic as a film barcode (7), which is used for outdoor lamp box.

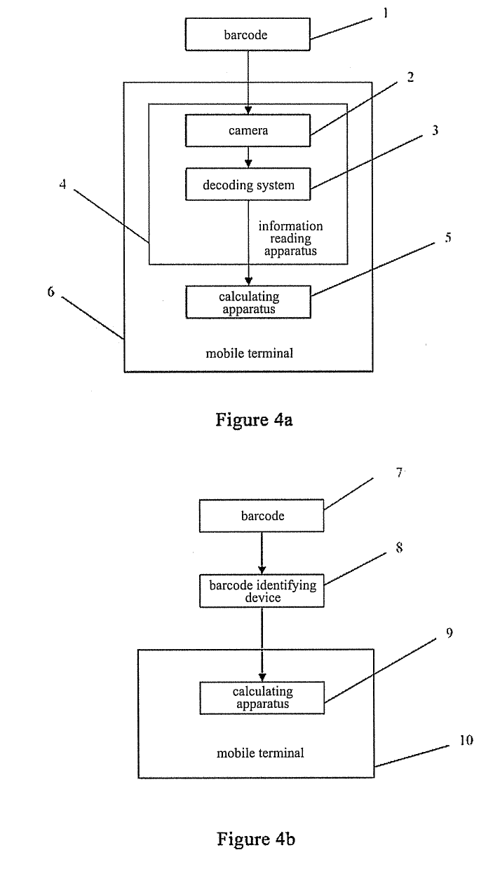

FIG. 4a is a block diagram of an information reading apparatus. A barcode (1) is read by a camera (2) installed in a mobile terminal (4) as graphic information, and is decoded by a decoding system (3). The decoded information is transferred to a calculating apparatus (5) of the mobile terminal (6).

FIG. 4b is a block diagram of another information reading apparatus. A barcode (7) is read as graphic information and decoded by a barcode identifying device (8). The decoded information is transferred to the calculating apparatus (5) of the mobile terminal (6) via wired or wireless link.

In example 1, two text segments such as “Welcome to ABC!” and “Please wait” are encoded into a barcode, and are displayed on a screen of a mobile terminal by identifying the barcode.

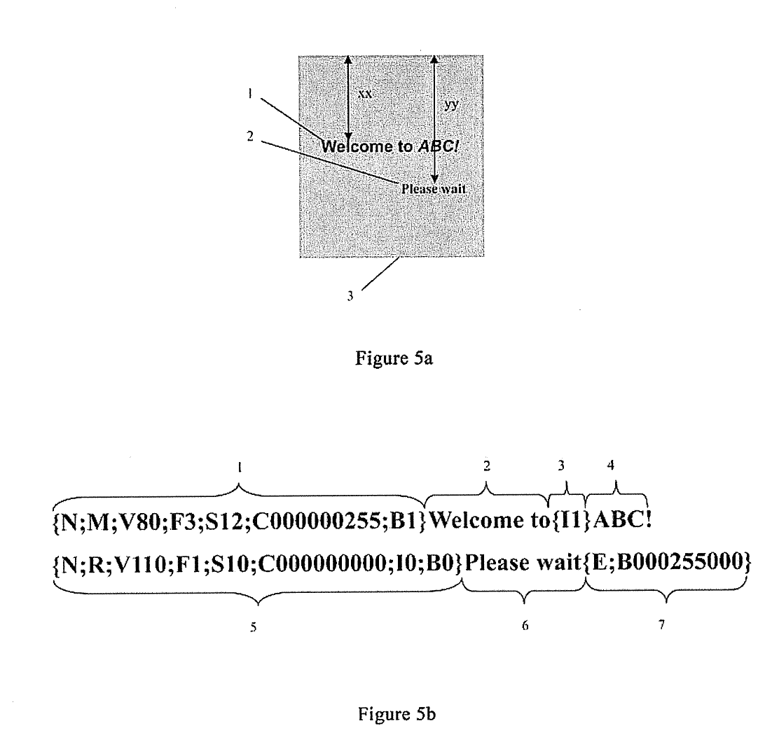

FIG. 5a is a schematic of contents displayed on a screen of a mobile terminal. In example 1, background color (3) of the screen is orange, the first segment of texts is “Welcome to ABC!” (1), the displayed font style is Arial in bold, font size is 12, color is navy blue, position is center-aligned with a margin-top of xx pixels from the top edge of the screen, and “ABC” is displayed as italic; the second segment of texts is “Please wait” (2), the displayed font style is Times New Roman in bold, font size is 10, color is black, horizontal position is right-aligned with a margin-top of yy pixels from the top edge of the screen.

In example 1, the symbol “{” in the coding information represents start of control information whereas the symbol “}” represents end of the control information. The control information is represented by characters and numbers, in which characters represent classes, for example, F represents font style and S represents font size, and numbers represent values of certain control information, for example, F3 represents the third kind of font style and S12 represents font size of 12. Different control information is spaced by symbol “;”. As such, the displayed information in FIG. 5a of example 1 is controlled by coding information as that in FIG. 5b.

In FIG. 5b, control information (1) {N;M;V80;F3;S12;C000000255;B1}, control information (3) {I1}, and control information (5) {N;R;V110;F1;S10;C000000000;I0;B0} are used to control the displaying of text information (2) “Welcome to”, text information (4) “ABC”, and text information (6) “Please wait” respectively. Control information (7) is used for controlling background color. Now, the principle for controlling will be described below in details: in control information (1), N represents starting a new line, M represents that this segment is center aligned, V80 represents that margin-top is 80 pixels, F3 represents the third kind of font style, S12 represents font size of 12, and C000000255 is a color code for characters, which represents navy blue in this example 1, and B1 represents bold; in control information (2), I1 represents italic, which controls for displaying text information (4) “ABC” as italic; in control information (3), N represents starting a new line, R represents that this segment is right-aligned, V110 represents that margin-top is 110 pixels, F1 represents the first kind of font style, S10 represents font size of 10, and C000000000 is a color code which represents black in this example 1, 10 represents normal (because last control symbol is I1“italic”, 10 switches back to normal), and B0 represents standard (because last control symbol is B1 “Bold”, B0 switches back to standard); in control information (7), E represents end, and B000255000 is a background color code which represents orange in this example 1.

In example 1, sequence of control symbols in a set of control symbols {N;M;V80;F3;S12;C000000255;B1} would not affect the controlling result. In other words, the above-mentioned set of control symbols may be written as {F3;S12;N;M;V80;C000000255;B1} without affecting the displaying result.

In example 1, classes of control symbols may be increased and may be represented by any characters. Significance digit of the number following a control symbol may be increased or reduced depending on different classes, but the amount of symbols should be limited as possible to improve the identifying speed for barcodes.

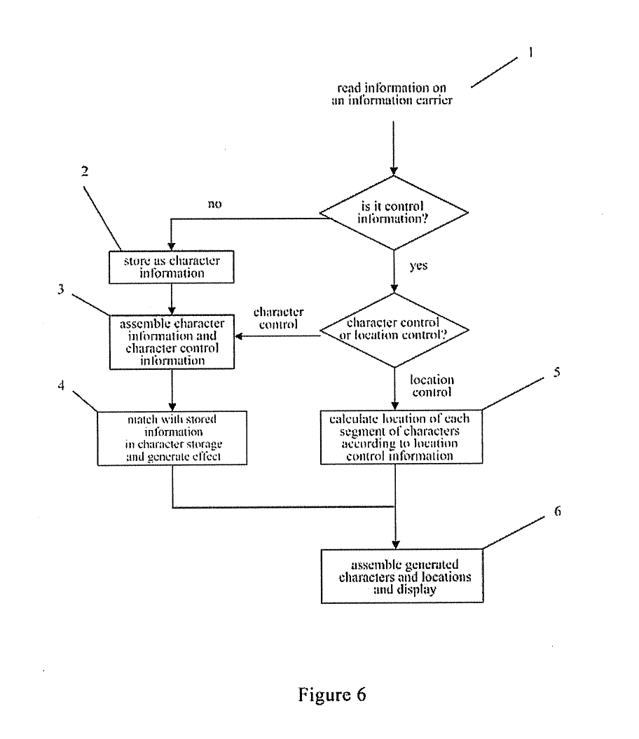

FIG. 6 is a flow chart of calculation within a mobile terminal. Information (1) read from an information carrier is determined by a calculating apparatus about whether the information is control information. If it is not control information, it is stored as character information (2); if it is control information, it is determined whether the information is character control information or location control information. If it is character control information, assembling character information and the character control information (3) in conjunction with stored character information (2), matching with those stored in a character storage and generating effect (4); if it is determined as location control information, calculating location of each character segment (5) according to the location control information, assembling generated characters and locations in conjunction with (4), and displaying (6).

In example 1, English is taken as example, but other languages may also be suitable for this method, and a language control symbol may be employed to represent for language, for example, D1 for English, D2 for Chinese, D3 for Japanese, and so on.

### Example 2

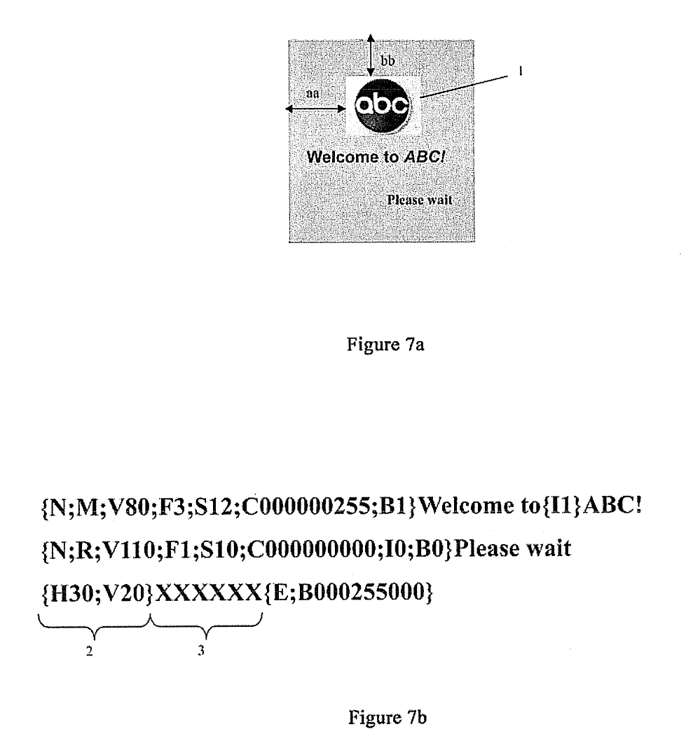

Example 2 of the present invention is to add image-displaying into example 1. FIG. 7a is a schematic of contents displayed on a screen of a mobile terminal. The image in example 2 is a Logo (1) of ABC, which is aa pixels apart from the left edge of the screen at top left corner and bb pixels apart from top edge of the screen.

In example 2, coding information is that of example 1 plus control information and image information for the Logo, which is shown as FIG. 7b. Control information {H30;V20} (2) and image information XXXXXX (3) are placed before background control information {E;B000255000}, which represent that the Logo (1) is positioned in FIG. 7a with 30 pixels apart from left edge of the screen at top left corner and 20 pixels apart from top edge of the screen, and the image information is XXXXXX (3).

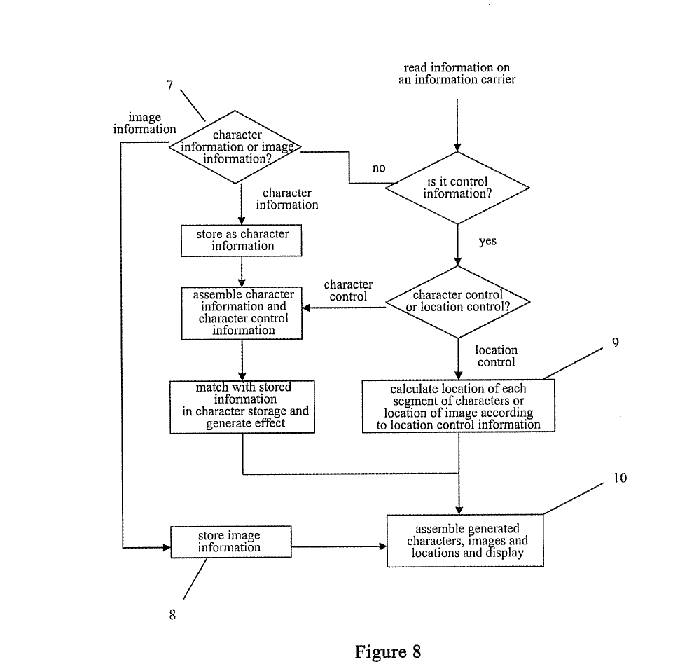

FIG. 8 is a flow chart of calculation within a mobile terminal of example 2. Based on FIG. 6, FIG. 8 is to add the operations of determining whether it is character information or image information (7) and storing the image information (8), and to change the operations (5) and (6) in FIG. 6 to the operations of calculating location of each character segment or the image (9) according to the location control information, assembling generated characters, the image and locations, and displaying (10) in FIG. 8.

### Example 3

Example 3 of the present invention is to change the barcode in example 1 to a non-contact IC card such as a RFID card. A RFID includes a winding and an IC chip. It uses energy of radio waves from a reading-writing device as power supply to generate information, and therefore eliminates the need for battery to perform dual-communication.

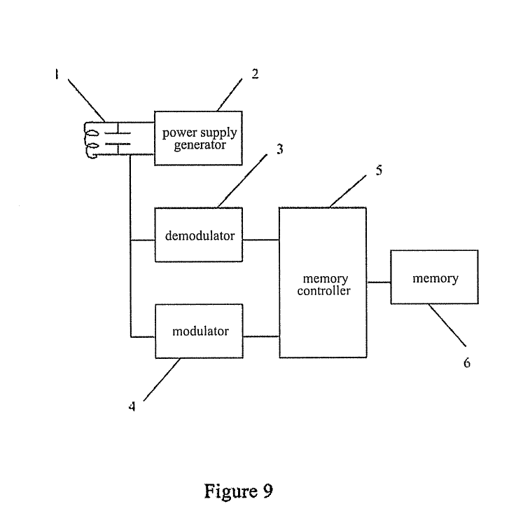

FIG. 9 is a block diagram representing a RFID. The RFID includes a resonant circuit (1) consisting of an antenna winding and a capacitor, a power supply generator (2) for providing signals from the resonant circuit (1) as power supply to each part, a demodulator (3) and a modulator (4) connected to the resonant circuit (1), a memory (6) and a memory controller (5). The memory controller (5) reads/writes information from/to the memory (6), the demodulator (3) receives and demodulates data, the modulator (4) modulates the data read by the memory controller (5) and sends the modulated data.

RFID may be stuck to a target medium. In the case that the target medium is a paper article such as a printed advertisement or magazine, the antenna part may be directly printed on paper, and the IC chip may be stuck to paper.

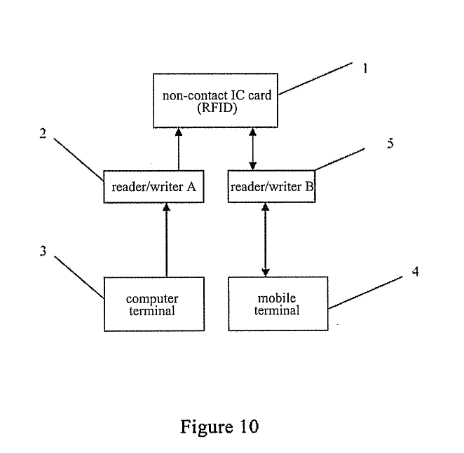

FIG. 10 is a block diagram for information writing and reading process of this example. Information is transmitted to a reader/writer A (2) in a wired or wireless manner via an apparatus such as computer terminal (3). The reader/writer A (2) writes the information into a non-contact IC card (RFID) (1) through radio waves in an operative range. A reader/writer B (5), which is mounted or connected to a mobile terminal (4), reads the information on the non-contact IC card (1), and transmits the information to the mobile terminal through an inner, wired or wireless connection. Furthermore, feedback information (for example, counting) from the mobile terminal may be re-written to the non-contact IC card (1) by the reader/writer B (5). Therefore, the feedback information may be read in another reading process. For example, this method may be practiced by displaying a counter on the mobile terminal to notice a user how many users have read the information on this RFID.

### Example 4

Example 4 of the present invention is to add function control information into example 1, for example, to add URL for accessing a web site or to add business card information for entering an address-book of a mobile terminal, so as to integrate shown information with a directed function thereof.

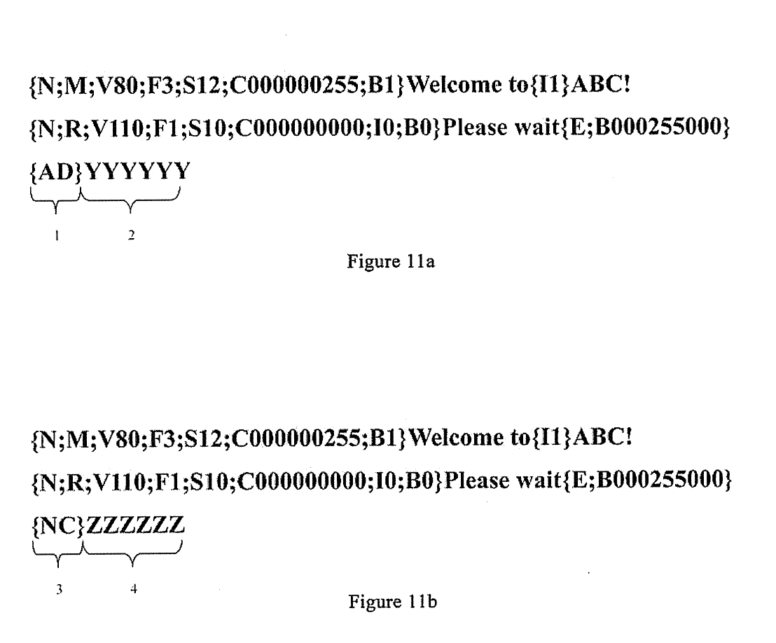

FIG. 11a is a schematic of coding information of an information carrier in accordance with one situation of example 4. That is, placing URL information after displayed information for linking to a designated web page. Control information {AD} (1) denotes that the following characters represent an URL linkage and YYYYYY (2) is the URL address or a code for the address (such as abc.go.com or 100232). As such, at the time of displaying the read information or afterwards, the mobile terminal may access the web page of the read URL via a network.

FIG. 11b is a schematic of coding information of an information carrier in accordance with another situation of example 4. That is, placing business card information after displayed information for transferring the business card information to an address book in a mobile terminal. Control information {NC} (3) denotes that the following characters represent business card information and ZZZZZZ (4) is the business card information (such as abc; 1234567). As such, at the time of displaying the read information or afterwards, the mobile terminal may read the business information such as “name: abc, phone number: 1234567” into the address book.

1-8. (canceled)

9. A method for controlling display of a mobile terminal comprising:
providing an information carrier carrying at least one content for displaying and associated control information;
reading the at least one content for displaying and the associated control information on the information carrier by a reading apparatus; and
displaying the at least one content according to the read control information to carry out predetermined displaying effect associated with the read control information.

10. The method for controlling display of mobile terminal in claim 9, wherein the content for displaying comprises at least one character and/or at least one image.

11. The method for controlling display of mobile terminal in claim 9, wherein the control information is location control information, and the displaying operation comprises calculating location of the content for displaying according to the location control information, and displaying the content according to the calculated location.

12. The method for controlling display of mobile terminal in claim 9, wherein the control information is character control information, and the displaying operation comprises assembling the content for displaying with the character control information and displaying.

13. The method for controlling display of mobile terminal in claim 9, wherein the control information is functional control information, and the method further comprises carrying out a function associated with the functional control information by the mobile terminal.

14. The method for controlling display of mobile terminal in claim 13, wherein the functional control information is an URL, and the method further comprises accessing a web site according to the URL.

15. The method for controlling display of mobile terminal in claim 13, wherein the functional control information is business card information, and the method further comprises entering an address-book of the mobile terminal and storing the business card information.

16. A device for controlling display of mobile terminal, the device comprising:
an information carrier carrying at least one content for displaying and associated control information; and
a mobile terminal, the mobile terminal comprising:
an information reading apparatus for reading the at least one content for displaying and the associated control information on the information carrier, and
a displaying apparatus for displaying the at least one content according to the read control information to carry out predetermined displaying effect associated with the read control information.

17. The device for controlling display of mobile terminal in claim 16, wherein the information reading apparatus is selected from a group consisting of a digital camera, a barcode identifying device, and a RFID reader/writer.

18. The device for controlling display of mobile terminal in claim 16, wherein the control information is location control information, and the mobile terminal further comprises a calculating apparatus for calculating location of the content for displaying according to the location control information, and the displaying apparatus displays the content according to the calculated location.

19. The device for controlling display of mobile terminal in claim 16, wherein the control information is character control information, and the displaying apparatus assembles the content for displaying with the character control information and carries out the predetermined displaying effect.

20. The device for controlling display of mobile terminal in claim 16, wherein the control information is functional control information, and the mobile terminal carries out a function associated with the functional control information.

21. The device for controlling display of mobile terminal in claim 20, wherein the functional control information is an URL, and the mobile terminal accesses a web site according to the URL.

22. The device for controlling display of mobile terminal in claim 20, wherein the functional control information is business card information, and the mobile terminal enters an address-book of the mobile terminal and stores the business card information.

23. The device for controlling display of mobile terminal in claim 16, wherein the mobile terminal comprises a mobile phone.
